(19) United States
(12) Patent Application Publication
(10) Pub. No.: US 2025/0216733 A1
(43) Pub. Date: Jul. 3, 2025

(54) DISPLAY DEVICE

(71) Applicant: LG Display Co., Ltd., Seoul (KR)

(72) Inventors: Yu Cheol YANG, Paju-sI (KR); Yong In PARK, Paju-si (KR); Seung Han PAEK, Paju-si (KR); Sang Pyo HONG, Paju-si (KR); Nam Woo KIM, Paju-si (KR)

(73) Assignee: LG Display Co., Ltd., Seoul (KR)

(21) Appl. No.: 18/988,831

(22) Filed: Dec. 19, 2024

(30) Foreign Application Priority Data
Dec. 29, 2023 (KR) 10-2023-0196923

(51) Int. Cl. G02F 1/1362

(52) U.S. Cl. CPC G02F 1/136286

(57) ABSTRACT

A light-emitting display device may include a first substrate including a display area and a non-display area including a bending area, a second substrate disposed on the display area of the first substrate to face the first substrate with a certain gap, a dummy substrate disposed to face a lower portion of the first substrate with the bending area of the non-display area therebetween, an etching prevention member provided on the first substrate and the dummy substrate to overlap the non-display area, and a link line unit formed on the etching prevention member.

### CROSS-REFERENCE TO RELATED APPLICATION

This application claims priority to and the benefit of Korean Patent Application No. 10-2023-0196923, filed on Dec. 29, 2023, the disclosure of which is incorporated herein by reference in its entirety.

### BACKGROUND

### 1. Field

The present disclosure relates to a display device.

### 2. Discussion of Related Art

Generally, display devices have been widely used as display screens of various electronic devices such as a mobile communication terminal, an electronic notebook, an electronic book, a portable multimedia player (PMP), a navigation device, an ultra mobile personal computer (UMPC), a mobile phone, a tablet personal computer (PC), a watch phone, an electronic pad, a wearable device, a portable information device, a vehicle control display device, a television, a notebook, a monitor, and the like.

Recently, research and development on a display device capable of implementing a maximum screen size by reducing a bezel area where an image is not displayed at the same display panel size have been conducted.

### SUMMARY

The present disclosure is directed to providing a display device capable of applying a backlight unit as a two-dimensional (2D) micro light-emitting diode (LED) and bending a link line area through patterning etching of a glass substrate to reduce a bezel in a lower end portion and implement a four-sided even bezel.

The technical objects of the present disclosure are not limited to the above-mentioned technical problems, and other technical objects which are not mentioned will be clearly understood by those skilled in the art from the following description.

To achieve these objects and other advantages of the present disclosure, as embodied and broadly described herein, a display device may include a first substrate including a display area and a non-display area including a bending area, a second substrate disposed on the display area of the first substrate to face the first substrate with a certain gap, a dummy substrate disposed to face a lower portion of the first substrate with the bending area of the non-display area therebetween, an etching prevention member provided on the first substrate and the dummy substrate to overlap the non-display area, and a link line unit formed on the etching prevention member.

In another aspect of the present disclosure, a display device may include a first glass substrate including a display area and a non-display area including a bending area, a second glass substrate disposed on the display area of the first glass substrate to face the first glass substrate with a certain gap, a liquid crystal layer disposed between the first and second glass substrates, a light source unit disposed on a rear surface of the first glass substrate, a dummy glass substrate disposed to face a lower portion of the first glass substrate with the bending area of the non-display area therebetween, an etching prevention member provided on the first glass substrate and the dummy glass substrate to overlap the non-display area, and a link line unit formed on the etching prevention member, and a bending portion formed on rear surfaces of the first glass substrate and the dummy glass substrate under the etching prevention member.

In yet another aspect of the present disclosure, a display device may include a first glass substrate including a display area and a non-display area including a bending area, a second glass substrate disposed on the display area of the first glass substrate to face the first glass substrate with a certain gap, a liquid crystal layer disposed between the first and second glass substrates, a dummy glass substrate disposed at a lower side of the first glass substrate with the bending area of the non-display area therebetween, a light source unit disposed on a rear surface of the first glass substrate and a side surface of the dummy glass substrate, an etching prevention member provided on the first glass substrate and the dummy glass substrate to overlap the non-display area, a link line unit formed on the etching prevention member, and a bending portion formed on rear surfaces of the first glass substrate and the dummy glass substrate under the etching prevention member.

In another aspect of the present disclosure, a display device may include a thin film transistor array substrate including a display area and a non-display area including a bending area, a color filter array substrate disposed on the display area of the thin film transistor array substrate to face the thin film transistor array substrate with a certain gap, a liquid crystal layer disposed between the thin film transistor array substrate and the color filter array substrate, a dummy glass substrate bent from the thin film transistor array substrate across the bending area of non-display area and disposed below the color filter array substrate, a light source unit disposed on a rear surface of the color filter array substrate and the dummy glass substrate, an etching prevention member provided on the thin film transistor array substrate and the dummy glass substrate to overlap the non-display area, a link line unit disposed on the etching prevention member, and a bending portion formed on rear surfaces of the thin film transistor array substrate and the dummy glass substrate under the etching prevention member.

### BRIEF DESCRIPTION OF THE DRAWINGS

The accompanying drawings, which are included to provide a further understanding of the present disclosure and are incorporated in and constitute a part of this application, illustrate example embodiments of the disclosure and together with the description serve to explain the principles of the disclosure. In the drawings:

FIG. 1 is a schematic block diagram of a display device according to an example embodiment of the present disclosure;

FIG. 2 is a perspective view of the display device according to an example embodiment of the present disclosure;

FIG. 3 is a cross-sectional view taken along line I-I′ in FIG. 2;

FIG. 4 is a cross-sectional view taken along line II-II′ in FIG. 2;

FIG. 5 is a perspective view of the bending of the display device according to an example embodiment of the present disclosure;

FIG. 6 is a cross-sectional view taken along line III-III′ in FIG. 5;

FIG. 7 is a plan view of the display device according to an example embodiment of the present disclosure;

FIG. 8 is a cross-sectional view taken along line IV-IV′ in FIG. 7;

FIG. 9 is a cross-sectional view taken along line V-V′ in FIG. 7;

FIG. 10 is a plan view of a bending area of an example of a link line unit of the display device according to an example embodiment of the present disclosure;

FIG. 11 is an enlarged view of portion A in FIG. 10;

FIG. 12 is a plan view of the bending area of another example of the link line unit of the display device according to an example embodiment of the present disclosure;

FIG. 13 is a plan view of the bending area of still another example of the link line unit of the display device according to an example embodiment of the present disclosure;

FIG. 14 is a cross-sectional view of the bending area of the display device according to an example embodiment of the present disclosure;

FIG. 15 is an enlarged view of portion B in FIG. 14;

FIG. 16 is a cross-sectional view of a display device according to another example embodiment of the present disclosure;

FIG. 17 is a cross-sectional view of a display device according to still another example embodiment of the present disclosure; and

FIG. 18 is a cross-sectional view of a display device according to yet another example embodiment of the present disclosure.

### DETAILED DESCRIPTION

Advantages and features of the present disclosure, and methods of achieving them will become apparent with reference to the following example embodiments, which are described in detail, in conjunction with the accompanying drawings. However, the present disclosure is not limited to the example embodiments to be described below and may be implemented in different forms. Rather, the example embodiments are only provided to more completely disclose the present disclosure and more completely convey the scope of the present disclosure to those skilled in the art. A protected scope of the present disclosure is defined by the disclosed claims and their equivalents.

Since the shapes, sizes, proportions, angles, numbers, and the like disclosed in the drawings for describing example embodiments of the present disclosure are only examples, the present disclosure is not limited to the illustrated items. Further, in describing the present disclosure, when it is determined that a detailed description of related known technology may unnecessarily obscure the gist of the present disclosure, the detailed description thereof will be omitted.

Where ‘including,’ ‘having,’ ‘consisting of,’ and the like are used in the present disclosure, other parts may be added unless a more limiting term like ‘only’ is used. A case in which a component is expressed in a singular form includes a plural form, and vice versa, unless explicitly stated otherwise.

In interpreting the components, it could be understood that an error range is included even when there is no separate explicit description.

In the case of a description of a positional relationship, for example, where the positional relationship of two parts is described as ‘on,’ ‘at an upper portion,’ ‘at a lower portion,’ ‘next to, and the like, one or more other parts may be located between the two parts unless a more limiting term like ‘immediately’ or ‘directly’ is used.

A case where an element or a layer is described as being on another element or layer includes both cases in which the element or layer is directly on the other element or layer and cases in which still another layer or element is interposed between the other element and the element.

Further, although terms “first,” “second,” and the like may be used to describe various components, these components are not limited by these terms. These terms are only used to refer to one component separately from another. Accordingly, a first component mentioned below may also be a second component, and vice versa, within the technical spirit of the present disclosure.

The same reference numerals indicate the same components throughout the disclosure unless otherwise specified.

The size and thickness of each component shown in the drawings are shown for convenience of description and are not necessarily limited to sizes and thicknesses of the components shown in the present disclosure.

Features of various embodiments of the present disclosure may be partially or entirely coupled or combined with each other, and technically, various linkages and operations are possible, and the embodiments may be implemented independently of each other or together in an interrelated relationship.

Hereinafter, an organic light-emitting display device according to example embodiments of the present disclosure will be described with reference to the accompanying drawings.

In the following description, where a detailed description of a relevant well-known function or configuration may unnecessarily obscure the principle of the present disclosure, the detailed description thereof may be omitted or briefly described.

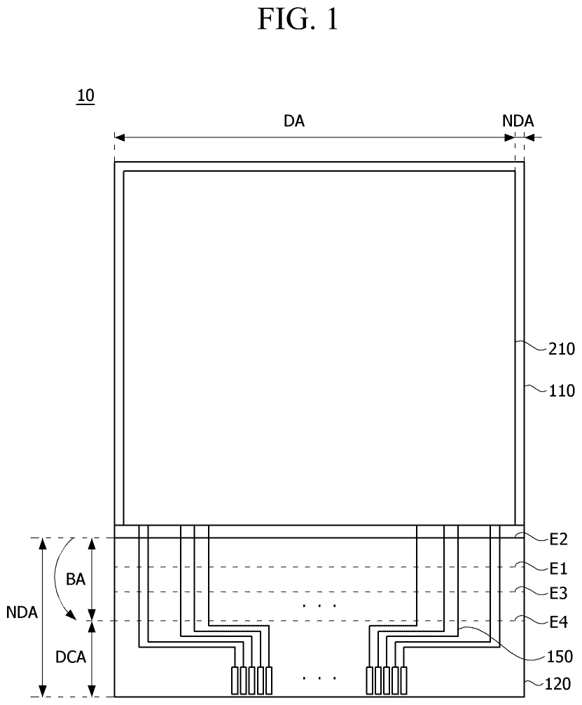

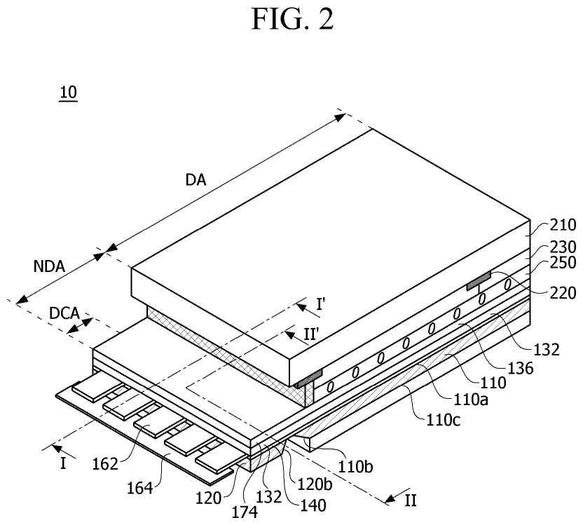

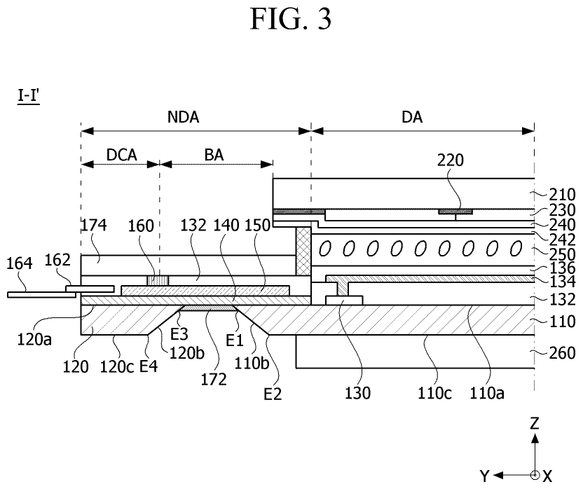

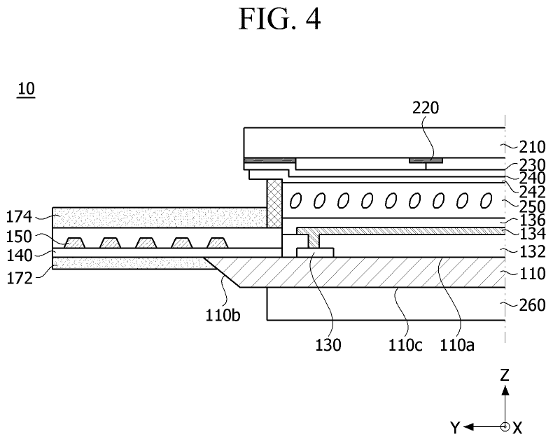

FIG. 1 is a schematic block diagram of a display device according to an example embodiment of the present disclosure, FIG. 2 is a perspective view of the display device according to an example embodiment of the present disclosure, FIG. 3 is a cross-sectional view taken along line I-I′ in FIG. 2, and FIG. 4 is a cross-sectional view taken along line II-II′ in FIG. 2.

A liquid crystal display device (LCD), a plasma display panel device (PDP), a field emission display device (FED), an electroluminescence display device (ELD), an organic light-emitting diode (OLED) display device, and the like may be used as the display device of the present disclosure, but in the present disclosure, a liquid crystal display device using a backlight unit or micro light-emitting diode (LED) as a light source will be used as an example among these display devices. However, the present disclosure is not limited thereto.

A display device 10 according to the present disclosure includes a first glass substrate 110, which is an array substrate including a thin film transistor, gate lines, data lines, and pixel electrodes, a second glass substrate 210, which is a color filter substrate including a color filter layer (not shown, 230 in FIG. 2), a liquid crystal layer 250 filled between the two substrates 110 and 210, and a light source unit 260 disposed under the first glass substrate 110 to emit light to an upper portion of the first glass substrate 110.

Further, as shown in FIGS. 1 to 4, the display device 10 according to an example embodiment of the present disclosure includes a display area DA and a non-display area NDA including a bending area BA, and includes the first glass substrate 110 and the second glass substrate 210 disposed to vertically face each other with a certain gap in the display area DA, and a dummy glass substrate 120 disposed to face a lower surface of the first glass substrate 110 with the bending area BA therebetween.

The first and second glass substrates 110 and 210 and the dummy glass substrate 120 may include a glass material. The first glass substrate 110 and the dummy glass substrate 120 according to an example may have thicknesses of 0.01 to 1.0 mm to maintain the flatness of a first flat surface 110a and a second flat surface 120a or block the permeation of moisture or oxygen into the display device. However, the thicknesses of the first glass substrate 110 and the dummy glass substrate 120 are not limited thereto and may be changed according to the design conditions of the display device.

The display area DA is an area where an image is displayed and may include a plurality of pixels. The display area DA may be supported by the first flat surface 110a of the first glass substrate 110.

The display area DA may include the plurality of pixels. The plurality of pixels may be disposed in a matrix form, and each of the plurality of pixels may include sub-pixels. The display area DA may have a roughly rectangular shape. Further, the embodiments of the present disclosure are not limited thereto, and the display area DA may have an arbitrary polygonal shape. In addition, for example, the display area DA may have a triangular shape, a pentagonal shape, or a hexagonal shape according to the shape of the display device. In the present disclosure, for convenience of description, the display area DA having a rectangular shape will be described below according to the display device 10 having a rectangular shape.

The non-display area NDA is an area surrounding the display area DA, and elements and circuit lines for driving the display area DA may be disposed therein.

The bending area BA may be defined as an area where a portion of the display device 10 is bent. Accordingly, the display device 10 according to an example of the present disclosure may be folded to have a certain radius of curvature according to bending of the bending area BA.

The display device 10 according to the example of the present disclosure may be defined as a flat area FA, the bending area BA, and a rear surface flat area RFA. Since the bending area BA is the same as the above description, a description thereof will be omitted.

The flat area FA may be defined as an area overlapping the first flat surface 110a of the first glass substrate 110. Further, the flat area FA may be an area overlapping the display area DA and including a certain non-display area NDA surrounding the display area DA.

The rear surface flat area RFA may be defined as an area overlapping the second flat surface 120a of the dummy glass substrate 120 and not overlapping the bending area BA. A driving circuit unit 160 and a printed circuit board (PCB) 164 may be provided in the rear surface flat area RFA.

The display device 10 according to an example embodiment of the present disclosure includes the first glass substrate 110 provided in the display area DA, the dummy glass substrate 120 provided in the non-display area NDA, an etching prevention member 140 provided to overlap the bending area BA, and a link line unit 150 formed on the etching prevention member 140 to overlap the non-display area NDA.

The first glass substrate 110 may include a first etched surface 110b provided to overlap the bending area BA. Here, the fact that the first etched surface 110b overlaps the bending area BA may mean that the first etched surface 110b faces a rear surface of the etching prevention member 140 overlapping the bending area BA. Further, when the bending area BA of the display device does not include the first etched surface 110b, since the display device has a structure which may not be bent, the bending area BA of the display device may be defined as overlapping the first etched surface 110b.

Further, the first glass substrate 110 may include the first flat surface 110a and the first etched surface 110b disposed at one side of the first flat surface 110a and further include a first rear surface 110c facing the first flat surface 110a.

In addition, in the first glass substrate 110, a first end E1 which is a boundary between the first flat surface 110a and the first etched surface 110b, and a second end E2 which is a boundary between the first etched surface 110b and the first rear surface 110c may be defined.

The slope of the first etched surface 110b may be defined by an inclined surface which connects the first end E1 and the second end E2. As shown in FIGS. 2 and 3, the first etched surface 110b is shown as having a convex curved surface, but the embodiments of the present disclosure are not limited thereto.

The dummy glass substrate 120 may include a second etched surface 120b provided to overlap the bending area BA. Here, the fact that the second etched surface 120b overlaps the bending area BA may mean that the second etched surface 120b faces a rear surface of the dummy glass substrate 120 overlapping the second etched surface 120b. Further, when the bending area BA of the display device 10 does not include the second etched surface 120b, since the display device 10 has a structure which may not be bent, the bending area BA of the display device 10 may be defined as overlapping the second etched surface 120b.

The dummy glass substrate 120 may include the second flat surface 120a and the second etched surface 120b disposed at one side of the second flat surface 120a and further include a second rear surface 120c facing the second flat surface 120a.

When the first etched surface 110b of the first glass substrate 110 and the second etched surface 120b of the dummy glass substrate 120 are formed as shown in FIG. 2, it may be referred to as having a reverse tapered shape or an undercut structure. Here, if the first end E1 and a third end E3 correspond to an opening pattern for etching, the reverse tapered shape may mean that an interval between the second end E2 and a fourth end E4 is wider than the opening pattern.

The etching prevention member 140 may be disposed to overlap the bending area BA. For example, the etching prevention member 140 may be disposed to overlap only the bending area BA.

The etching prevention member 140 may be a configuration for preventing or reducing damage due to etching of the display device overlapping the first etched surface 110b and the second etched surface 120b when an etching process to prepare the first glass substrate 110 and the dummy glass substrate 120 according to an example embodiment of the present disclosure is performed. Accordingly, the etching prevention member 140 may be disposed to overlap the bending area BA of the display device.

Further, the etching prevention member 140 may overlap the bending area BA, overlap the first flat surface 110a of the first glass substrate 110 extending to one side of the bending area BA, and overlap the second flat surface 120a of the dummy glass substrate 120 extending to the other side of the bending area BA.

Here, the etching prevention member 140 may be composed of an organic material, and specifically, may be composed of a material which is resistant to a glass etchant. For example, an etchant including phosphoric acid (HNO₃) or hydrofluoric acid (HF) may be used as the etchant for glass etching. The etching prevention member 140 may be composed of either metal or an organic material.

The etching prevention member 140 may include at least one of a silicone-based organic material, urethane, polyimide, and photo acrylic. Alternatively, the etching prevention member 140 may include at least one of chromium (Cr), aluminum (Al), platinum (Pt), gold (Ag), and nickel (Ni).

The etching prevention member 140 is provided to protect a configuration located on the etching prevention member 140 during a process of forming the first etched surface 110b and the second etched surface 120b of the first glass substrate 110 and the dummy glass substrate 120, and the etching prevention member 140 may have a size wider than an area overlapping the first etched surface 110b of the first glass substrate 110 and the second etched surface 120b of the dummy glass substrate 120, or a size wider than the bending area BA.

The etching prevention member 140 according to an example embodiment of the present disclosure may prevent or reduce the display device from being damaged by an etchant used in a glass etching process of forming the first etched surface 110b of the first glass substrate 110 and the second etched surface 120b of the dummy glass substrate 120. The etching prevention member 140 may be composed of a material which is corrosion-resistant (or resistant) to the etchant used in the glass etching process.

According to an example embodiment of the present disclosure, the etching prevention member 140 may be prepared by spraying a material at a set location in a mechanical manner such as a slit coater, an inkjet, or a dispenser, or may be prepared by a patterning process using a photolithography mask.

Thus, as the display device 10 according to an example embodiment of the present disclosure includes the etching prevention member 140 disposed between the first etched surface 110b of the first glass substrate 110 and the second etched surface 120b of the dummy glass substrate 120 overlapping the bending area BA and the link line unit 150, the damage to the display device 10 caused by the glass etching process of forming the first etched surface 110b of the first glass substrate 110 and the second etched surface 120b of the dummy glass substrate 120 may be prevented.

The etching prevention member 140 may be defined as an etch stop pattern, an etch barrier pattern, an etch mask pattern, or the like.

Further, in consideration of a process margin due to etching in the process of forming the first etched surface 110b of the first glass substrate 110 and the second etched surface 120b of the dummy glass substrate 120, the etching prevention member 140 may be formed to overlap the areas extending to one side and the other side of the bending area BA. Specifically, the etching prevention member 140 may be formed to overlap the first flat surface 110a of the first glass substrate 110 and the second flat surface 120a of the dummy glass substrate 120 by a certain area. When the etching prevention member 140 is formed to extend to one side and the other side of the bending area BA, the stability of an etching process for forming the first etched surface 110b of the first glass substrate 110 and the second etched surface 120b of the dummy glass substrate 120 may be improved.

Meanwhile, as another example of the etching prevention member 140 of the present disclosure, to strengthen the adhesion with the glass substrate and supplement the thickness, an inorganic film or a stacked structure of an inorganic film and a metal film may be further formed between a lower portion of the etching prevention member 140 and the first glass substrate 110 as well as between a lower portion of the etching prevention member 140 and the dummy glass substrate 120 located in the bending area BA of the non-display area NDA of the first glass substrate 110. In this case, a gate insulating film or an interlayer insulating film when forming a thin film transistor may be used as the inorganic film. For example, the inorganic film may include SiO₂, SiNₓ, a-Si, or the like. Further, a metal layer used to form a gate electrode or source/drain electrodes may be used as the metal film. For example, the metal film may include molybdenum (Mo), MoTi, ITO, or the like.

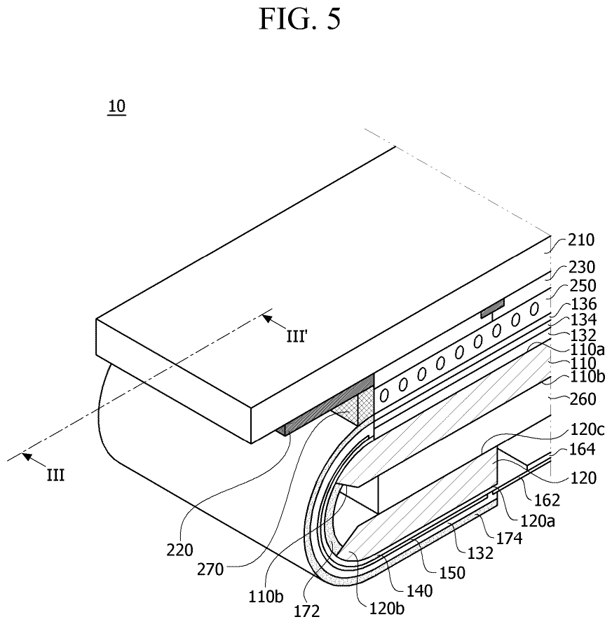

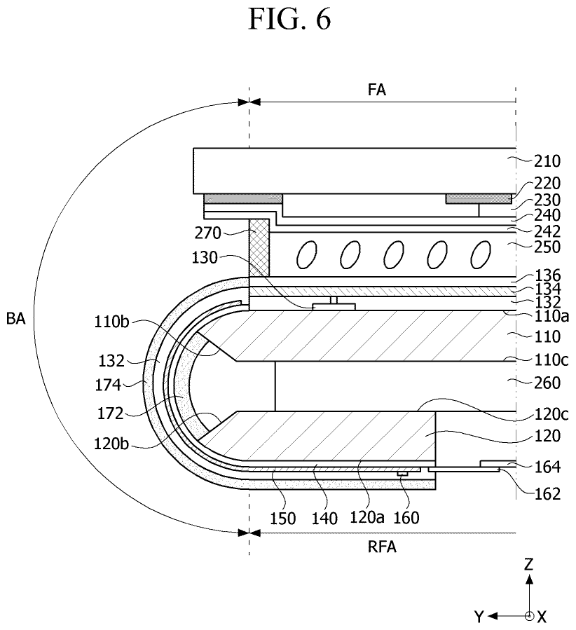

FIG. 5 is a perspective view of the bending of the display device according to an example embodiment of the present disclosure, and FIG. 6 is a cross-sectional view taken along line III-III′ in FIG. 5.

As shown in FIG. 5, in the display device 10 according to an example embodiment of the present disclosure, the light source unit 260 is disposed on the rear surface of the first glass substrate 110 located in the display area DA. A two-dimensional (2D) micro-LED (μ-LED) may be applied as the light source unit 260. In the embodiment, a case of using the 2D micro-LED as a light source will be described as an example. However, the present disclosure is not limited thereto, and other light sources may also be applied.

Here, a front surface of the light source unit 260 may be disposed in contact with the rear surface 110c of the first glass substrate 110.

Further, a rear surface of the light source unit 260 may be disposed in contact with the rear surface 120c of the bent dummy glass substrate 120.

In addition, in the display device 10 according to an example embodiment of the present disclosure, since the bending area BA is bent, the first rear surface 110c of the first glass substrate 110 and the front surface of the light source unit 260 and the second rear surface 120c of the dummy glass substrate 120 are disposed to face each other.

A contact portion of the first rear surface 110c of the first glass substrate 110 and the front surface of the light source unit 260 and the second rear surface 120c of the dummy glass substrate 120 may further include an adhesive member (not shown) for fixing the light source unit 260 and the dummy glass substrate 120 to the first glass substrate 110.

The adhesive member (not shown) may be an optically clear adhesive (OCA), an optically clear resin (OCR), a pressure sensitive adhesive (PSA), or a double-sided adhesive tape, but is not limited thereto.

The display area DA of the first glass substrate 110 may include the first flat surface 110a and the first etched surface 110b formed at one side of the first flat surface 110a, and further include the first rear surface 110c facing the first flat surface 110a.

The first flat surface 110a of the first glass substrate 110 may overlap the display area DA and the flat area FA of the display device 10.

The first etched surface 110b of the first glass substrate 110 may be formed to overlap the etching prevention member 140.

The first etched surface 110b may be formed in the remaining portion except for the first flat surface 110a among an upper surface of the first glass substrate 110 overlapping the display area DA and the bending area BA of the non-display area NDA. According to the present disclosure, the first etched surface 110b may be formed in a streamlined and convex cross-sectional shape while having a non-flat structure by performing an etching process on the first glass substrate 110 having a flat plate shape and removing (or etching) a portion of the first flat surface 110a. Further, the first etched surface 110b may be provided to have a continuous surface with the first flat surface 110a.

The first etched surface 110b of the first glass substrate 110 and the second etched surface 120b of the second glass substrate 210 may have a reverse tapered shape and a curved surface.

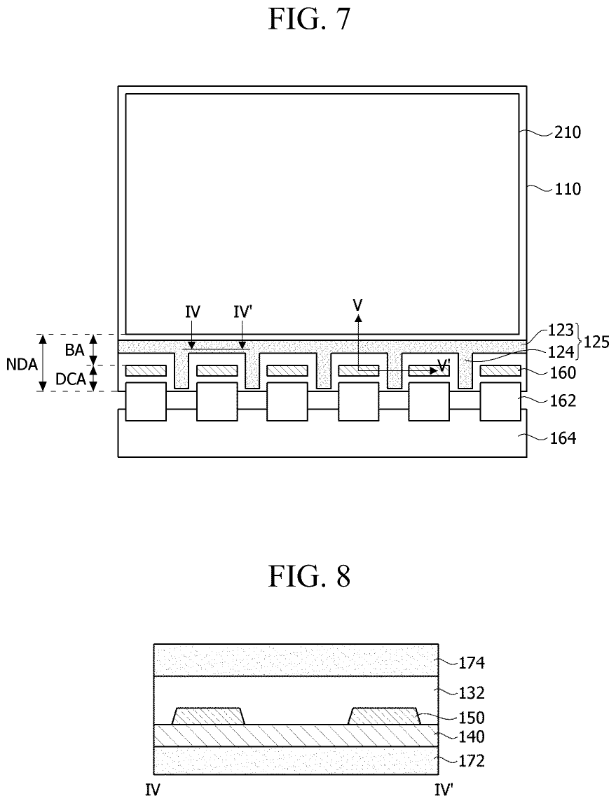

A detailed structure of a bending etched portion formed in the bending area BA of the non-display area NDA of the first glass substrate 110 will be described below with reference to FIGS. 7 to 9.

Meanwhile, a description of the display device according to an example embodiment of the present disclosure is as follows. The display device according to the embodiment will be described focusing on the liquid crystal display device.

As shown in FIGS. 5 and 6, the display device 10 according to an example embodiment of the present disclosure includes the first glass substrate 110 including the display area DA and the non-display area NDA including the bending area BA, the second glass substrate 210 disposed on the first glass substrate 110 in the display area DA to face the first glass substrate 110 with a certain cell gap, the liquid crystal layer 250 disposed between the first and second glass substrates 110 and 210, the dummy glass substrate 120 bent and disposed under the first glass substrate 110 with the bending area BA therebetween, and the light source unit 260 disposed between the first glass substrate 110 and the dummy glass substrate 120.

Although not shown in the drawing, a thin film transistor (TFT) 130 including a gate electrode, an ohmic contact layer, a source electrode, and a drain electrode is formed on the first flat surface 110a of the first glass substrate 110 of the display area DA constituting the display device 10 according to the embodiment.

An interlayer insulating film or a planarization layer 132 is formed on the front surface of the first flat surface 110a including the thin film transistor 130, and a pixel electrode 134 electrically connected to the thin film transistor 130 through a drain contact hole (not shown) is formed on the planarization layer 132.

A first alignment film 136 may be formed on the pixel electrode 134 to facilitate the alignment of liquid crystals.

Meanwhile, black matrices 220 are formed at a certain interval on the second glass substrate 210 disposed to correspond to the first glass substrate 110 of the display area DA with a certain cell gap.

The black matrices 220 may have a closed loop shape surrounding the display area DA to block light leakage. Further, the black matrices 220 may also correspond to an area corresponding to the thin film transistor 130, gate lines (not shown), and data lines of the first glass substrate 110 to block light leakage. In addition, the black matrices 220 are provided between the color filter layers 230 to prevent or reduce color mixing between the color filter layers 230.

Red (R), green (G), and blue (B) color filter layers 230 which filter only light in a specific wavelength range may be provided between the black matrices 220. The color filter layers 230 may include an acrylic resin and a pigment. The color filter layers 230 may be divided into red (R), green (G), and blue (B) according to the type of pigment which implements a color.

Further, an overcoat layer (not shown) may be further formed on the black matrices 220 and the color filter layers 230. The overcoat layer (not shown) may be provided to protect the color filter layers 230, flatten the surfaces, and improve adhesion with a common electrode 240, and may be composed of an acrylic-based resin.

The common electrode 240 may be provided on the overcoat layer (not shown). The common electrode 240 may be formed of a transparent conductive material. For example, the common electrode 240 may be composed of indium tin oxide (ITO) or indium zinc oxide (IZO).

A second alignment film 242 may be formed on the common electrode 240 to facilitate the alignment of liquid crystals.

Meanwhile, although not shown in the drawings, a spacer (not shown) which serves to maintain a certain cell gap may be additionally formed between the first glass substrate 110 and the second glass substrate 210.

Further, since a seal line 270 is disposed in the non-display area NDA of the first glass substrate 110 and the second glass substrate 210, the first and second glass substrates 110 and 210 are bonded by the seal line 270.

The seal line 270 may be provided on the planarization layer 132 to be spaced apart from the first alignment film 136, and may be disposed to face the planarization layer 132 and the black matrices 220. The seal line 270 may be composed of a sealant, and for example, the sealant may be a photo-curable epoxy resin or thermo-curable epoxy resin. The seal line 270 forms a gap for liquid crystal injection, and serves to prevent or reduce the injected liquid crystals from leaking. This seal line 270 is formed by forming a thermo-curable resin in a certain pattern on the first glass substrate 110, and then disposing the second glass substrate 210 on the first glass substrate 110 and pressing and curing the first glass substrate 110 and the second glass substrate 210 to bond the two substrates 110 and 210.

The liquid crystal layer 250 may be provided in an area where the certain cell gap is formed between the first glass substrate 110 and the second glass substrate 210. The liquid crystal layer 250 may include liquid crystals having optical anisotropic properties.

Although not shown in the drawings, in the display device 10 according to an example embodiment of the present disclosure, a voltage is applied to the pixel electrode 134 through the drain electrode and a voltage is applied to the common electrode 240 to display an image by driving a liquid crystal cell.

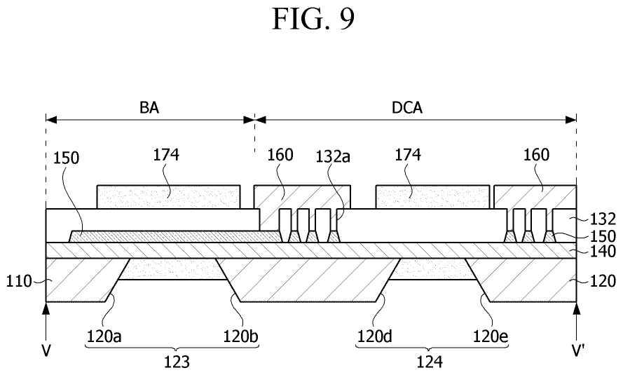

FIG. 7 is a plan view of the display device according to an example embodiment of the present disclosure, FIG. 8 is a cross-sectional view taken along line IV-IV′ in FIG. 7, and FIG. 9 is a cross-sectional view taken along line V-V′ in FIG. 7.

As shown in FIGS. 7 to 9, the non-display area NDA of the first glass substrate 110 and the dummy glass substrate 120 includes the bending area BA and a driving circuit area DCA. The bending area BA is provided at the first glass substrate 110 and the dummy glass substrate 120. Further, a plurality of link line units 150 forming a unit block are located in the bending area BA at regular intervals.

The driving circuit area DCA is located at the dummy glass substrate 120. In the driving circuit area DCA, driving circuits 160 connected to the plurality of link line units 150 forming the unit block and a plurality of flexible printed circuits (FPCs) 162 connected to the driving circuits 160 are disposed. The plurality of link line units 150 are respectively connected to external printed circuit boards (PCBs) 164 through the plurality of FPCs 162 which are flexible films.

The PCB 164 is formed with a plurality of elements such as integrated circuits provided on the first glass substrate 110 and generates various control signals, data signals, and the like for driving the display device 10.

The bending area BA of the non-display area NDA of the first glass substrate 110 and the dummy glass substrate 120 is located to overlap the link line units 150. A bending etched portion 125 is formed on lower surfaces of the first glass substrate 110 and the dummy glass substrate 120 located to overlap the bending area BA. The bending etched portion 125 includes a first bending etched portion 123 and a second bending etched portion 124. The bending etched portion 125 is also referred to as a bending portion.

The first bending etched portion 123 is formed along a longitudinal direction in the bending area BA of the non-display area NDA of the first glass substrate 110 and the dummy glass substrate 120. The first bending etched portion 123 includes the first etched surface 110b formed on the lower surface of the first glass substrate 110 and the second etched surface 120b formed on the lower surface of the dummy glass substrate 120.

Further, the second bending etched portion 124 is located to overlap the driving circuit area DCA located at the dummy glass substrate 120, and is formed on the lower surface of the dummy glass substrate 120 between the link line units 150 forming the unit block. The second bending etched portion 124 is formed to be perpendicular to the first bending etched portion 123 to have a continuous surface with the first bending etched portion 123. Further, the second bending etched portion 124 is formed in each area between the link line units 150 forming the unit block.

The second bending etched portion 124 includes a third etched surface 120d and a fourth etched surface 120e formed on the lower surface of the dummy glass substrate 120. The second bending etched portion 240b is located in the driving circuit area DCA between the plurality of FPCs 162 and thus does not overlap the link line units 150 forming the unit block.

Further, the first bending etched portion 123 and the second bending etched portion 124 are formed integrally to have the continuous surface and are connected to each other.

The etching prevention member 140 is formed on the bending area BA and the driving circuit area DCA at least overlapping the first bending etched portion 123 and the second bending etched portion 124. The plurality of link line units 150 are formed on the etching prevention member 140. Further, a portion of the planarization layer 132 formed on the display area DA is formed to extend from upper portions of the plurality of link line units 150.

In addition, a first coating layer 172 is formed under the etching prevention member 140 overlapping the first bending etched portion 123 and the second bending etched portion 124.

In addition, a second coating layer 174 is formed on the planarization layer 132 formed on the etching prevention member 140 overlapping the first bending etched portion 123 and the second bending etched portion 124. The second coating layer 174 may be formed to cover the seal line (not shown, 270 in FIG. 6) or surround a side surface.

The first and second coating layers (micro coating layers) 172 and 174 may be formed on the first glass substrate 110, the dummy glass substrate 120, the link line units 150, and the etching prevention member 140 in the bending area BA and the rear surface flat area RFA.

When the first glass substrate 110 and the dummy glass substrate 120 are bent, since cracks may occur due to a tensile force which acts on the link line units 150 disposed on the etching prevention member 140, the first and second coating layers 172 and 174 may serve to protect lines by forming a resin at a bending position with a thin thickness. The first and second coating layers 172 and 174 may be composed of an acrylic material such as an acrylate polymer.

The first and second coating layers 172 and 174 may adjust the neutral plane of the bending area BA. When structures are bent, the neutral plane may refer to a virtual surface which does not receive stress because the compressive force and tensile force applied to the structures are offset by each other. When two or more structures are stacked, a virtual neutral plane may be formed between the structures.

When the structures are entirely bent in one direction, the structures disposed in the bending direction with respect to the neutral plane are compressed by the bending and thus receive a compressive force. On the other hand, the structures disposed in a direction opposite the bending direction with respect to the neutral plane are elongated by the bending and thus receive a tensile force. Further, since the structures are more vulnerable when receiving the tensile force among the same compressive force and tensile force, the probability of cracks occurring is higher when receiving the tensile force.

The etching prevention member 140 disposed under the neutral plane is compressed and thus may receive a compressive force, the link line units 150 disposed above may receive a tensile force, and cracks may occur due to this tensile force. Accordingly, to minimize or reduce the tensile force on the lines, the lines may be located on the neutral plane.

As the first and second coating layers 172 and 174 are disposed on the bending area BA and the driving circuit area DCA, the neutral plane may be raised upward, and since the lines are formed at the same position as the neutral plane or a position higher than the neutral plane, and thus do not receive stress or receive a compressive force during bending, cracks may be suppressed from occurring.

Further, the driving circuit unit (D-IC) 160 is electrically connected to the plurality of link line units 150. The driving circuit unit 160 is connected in one-to-one contact with the plurality of link line units 150 through a plurality of link line contact holes 132a formed in the planarization layer 132.

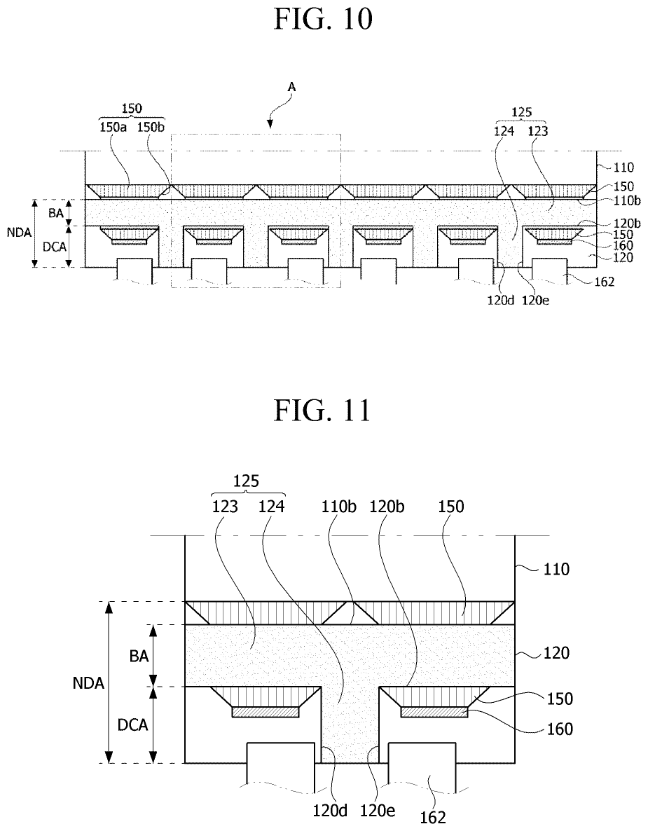

FIG. 10 is a plan view of the bending area of an example of a link line unit of the display device according to an example embodiment of the present disclosure, and FIG. 11 is an enlarged view of portion A in FIG. 10.

As shown in FIGS. 10 and 11, in the display device 10 according to an example embodiment of the present disclosure, the non-display area NDA of the first glass substrate 110 and the dummy glass substrate 120 includes the bending area BA and the driving circuit area DCA. The bending area BA overlaps the first glass substrate 110 and the dummy glass substrate 120. Further, the driving circuit area DCA overlaps the dummy glass substrate 120 and partially overlaps the driving circuit unit 160 and the FPC 162.

The plurality of link line units 150 arranged in the non-display area NDA form a plurality of blocks in one block unit, and these blocks are disposed at regular intervals.

Further, the plurality of blocks are respectively connected to the plurality of driving circuit units 160, and the plurality of driving circuit units 160 are respectively connected to the plurality of FPCs 162.

The plurality of link line units 150 connected to the plurality of driving circuit units (D-IC) 160 are connected to the external printed circuit board (PCB) 164 through the flexible printed circuits (FPCs) 162, respectively.

The bending etched portion 125 includes the first bending etched portion 123 formed on the lower surfaces of the first glass substrate 110 and the dummy glass substrate 120 overlapping the bending area BA and the second bending etched portion 124 formed on the lower surface of the dummy glass substrate 120. Here, the bending etched portion 125 is also called a bending portion.

The first bending etched portion 123 overlaps the plurality of link line units 150, and the second bending etched portion 124 does not overlap the plurality of link line units 150.

Further, the second bending etched portion 124 is formed on the lower surface of the dummy glass substrate 120 located in an area between the plurality of link line units 150 forming each unit block.

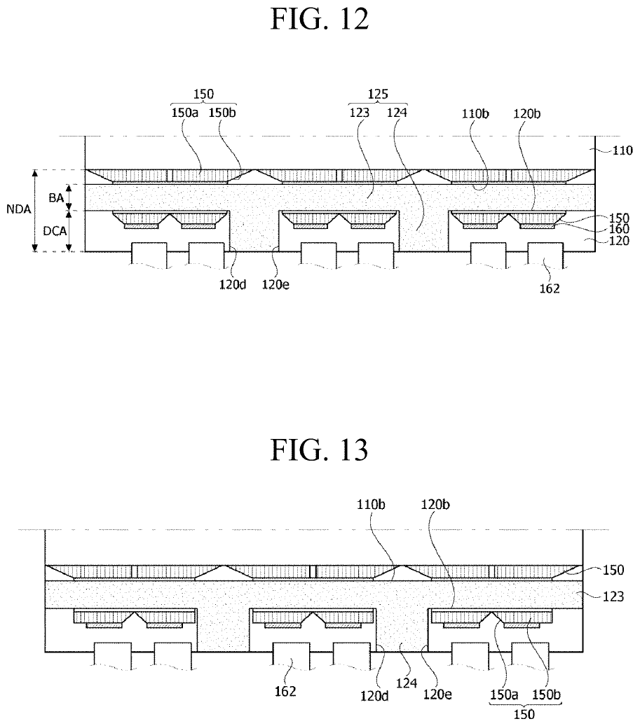

FIG. 12 is a plan view of the bending area of another example of the link line unit of the display device according to an example embodiment of the present disclosure.

As shown in FIG. 12, in another example of the non-display area NDA of the display device 10 according to the present disclosure, the non-display area NDA of the first glass substrate 110 and the dummy glass substrate 120 includes the bending area BA and the driving circuit area DCA. The bending area BA overlaps the first glass substrate 110 and the dummy glass substrate 120. Further, the driving circuit area DCA overlaps the dummy glass substrate 120 and partially overlaps the driving circuit unit 160 and the FPC 162.

Two driving circuit units 160 connected to the plurality of link line units 150 disposed in the non-display area NDA are defined as one unit block. Two blocks of the driving circuit units 160 are disposed at a certain interval.

Further, the plurality of driving circuit units 160 are respectively connected to the plurality of FPC units 162.

The plurality of link line units 150 connected to the plurality of driving circuit units (D-IC) 160 are connected to the external printed circuit board (PCB) 164 through the flexible printed circuits (FPCs) 162, respectively.

The bending etched portion 125 includes the first bending etched portion 123 formed on the lower surfaces of the first glass substrate 110 and the dummy glass substrate 120 overlapping the bending area BA and the second bending etched portion 124 formed on the lower surface of the dummy glass substrate 120.

The first bending etched portion 123 overlaps the plurality of link line units 150, and the second bending etched portion 124 does not overlap the plurality of link line units 150.

Further, the second bending etched portion 124 is formed on the lower surface of the dummy glass substrate 120 located in an area between the two driving circuit units 160 forming each unit block.

Specifically, one ends of the link line units 150 extending from the display area DA to the non-display area NDA may be asymmetrically disposed, and the other ends of the link line units 150 connected to the driving circuit unit 160 may be symmetrically disposed. That is, a line length of the outermost link line units 150 extending from the display area DA to the non-display area NDA may be disposed to be longer than a line length of other link line units 150 adjacent to each other.

Thus, in another example of the present disclosure, when two driving circuit units 160 are designed as one block and the second bending etched portion is formed in an area between these blocks, since an etching area is further secured compared to a case in which one driving circuit unit 160 is designed as a unit block, an etching margin may be secured to that extent when the bending etched portion is formed.

FIG. 13 is a plan view of the bending area according to still another example of the link line unit of the display device according to an example embodiment of the present disclosure.

As shown in FIG. 13, in still another example of the non-display area NDA of the display device 10 according to the present disclosure, one ends of the link line units 150 extending from the display area DA to the non-display area NDA may be asymmetrically disposed, and the other ends of the link line units 150 connected to the driving circuit unit 160 may also be asymmetrically disposed. That is, a line length of the outermost link line units 150a extending from the display area DA to the non-display area NDA may be disposed to be longer than a line length of other link line units 150b adjacent to each other. Further, a line length of the line units 150b disposed adjacent to each other in the blocks connected to the driving circuit units 160 may be disposed to be longer than a line length of the outermost link line units 150a of the blocks connected to the driving circuit units 160.

Thus, to secure an etching margin between the FPCs 162, as the link line units 150 are asymmetrically designed and disposed, line resistance may be compensated and an interval of coupling between the driving circuit unit 160 and the FPC 162 may be certainly maintained.

Further, the line resistance may be certainly adjusted by adjusting the widths and lengths of the link lines on the bending area BA (that is, link lines close to the display area DA) and link lines under the bending area BA (that is, link lines close to the driving circuit unit 160).

Accordingly, since a line length of the link lines adjacent to the second bending etched portion 124 is shorter than a line length of the link lines disposed far from the second bending etched portion 124, line resistance may be reduced.

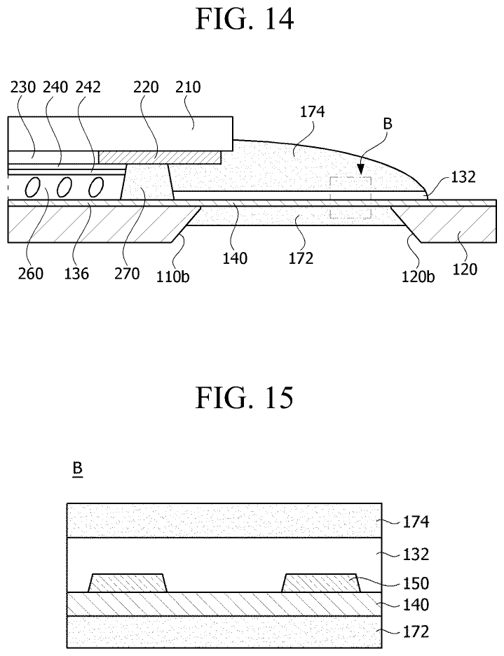

FIG. 14 is a cross-sectional view of the bending area of the display device according to an example embodiment of the present disclosure, and FIG. 15 is an enlarged view of portion B in FIG. 14.

As shown in FIGS. 14 and 15, the first coating layer 172 is formed on the first bending etched portion 123 formed in the bending area BA located at the lower surfaces of the first glass substrate 110 and the dummy glass substrate 120 which are overlappingly located in the non-display area NDA and the second bending etched portion 124 formed in the driving circuit area DCA of the dummy glass substrate 120.

Further, the second coating layer 174 which surrounds or covers the seal line 270 may be formed on the non-display area NDA. The etching prevention member 140, the link line units 150, and the planarization layer 132 may be formed under the second coating layer 174. The etching prevention member 140 may be composed of a transparent organic film. Further, a transparent organic film applied as an organic film may also be used as an alignment film.

In addition, as the first coating layer and the second coating layer are respectively formed under and on the non-display area of the first glass substrate which is located to overlap upper and lower portions of the bending etched portion, the lines may be protected when the display device is bent.

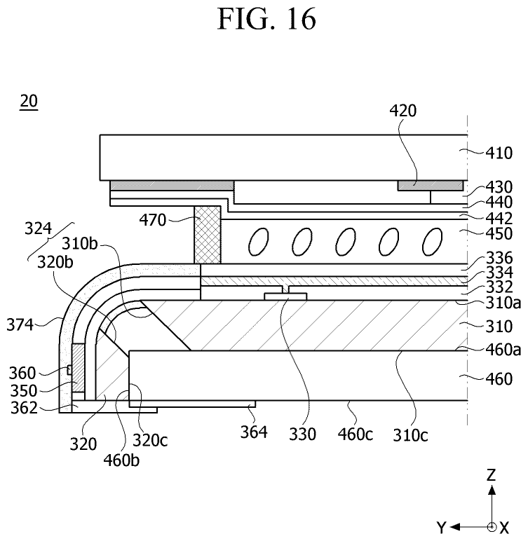

A display device according to another example embodiment of the present disclosure will be described with reference to FIG. 16 as follows.

FIG. 16 is a cross-sectional view of the display device according to another example embodiment of the present disclosure.

In another example embodiment of the present disclosure, a case of using a 2D micro-LED as a light source will be described as an example. However, the present disclosure is not limited thereto, and other light sources may also be applied. The display device according to another example embodiment of the present disclosure will be described focusing on the liquid crystal display device.

As shown in FIG. 16, a display device 20 according to another example embodiment of the present disclosure includes a first glass substrate 310 including a display area DA and a non-display area NDA including a bending area BA, and a second glass substrate 410 disposed on the first glass substrate 310 in the display area DA to face the first glass substrate 310 with a certain cell gap.

A dummy glass substrate 320 is bent from the first glass substrate 310 and located at a lower side of the first glass substrate 310 with the bending area BA of the non-display area NDA therebetween.

An etching prevention member 340 is formed on the first glass substrate 310 and the dummy glass substrate 320 to overlap the bending area BA. A link line unit 350 overlapping the bending area BA is disposed on the etching prevention member 340.

A front surface 460a of a light source unit 460 is disposed in contact with a rear surface 310c of the first glass substrate 310 located in the display area DA. A 2D micro-LED (μ-LED) may be applied as the light source unit 460. The present disclosure is not limited thereto, and other light sources may also be applied.

A rear surface 320c of the bent dummy glass substrate 320 is disposed in contact with a side surface 460b of the light source unit 460.

A contact portion of the rear surface 310c of the first glass substrate 310 and the side surface 460b of the light source unit 460 and the second rear surface 320c of the dummy glass substrate 320 may further include an adhesive member (not shown) for fixing the light source unit 460 and the dummy glass substrate 320 to the first glass substrate 310.

The adhesive member (not shown) may be an optically clear adhesive (OCA), an optically clear resin (OCR), a pressure sensitive adhesive (PSA), or a double-sided adhesive tape, but is not limited thereto.

The first glass substrate 310 may include a first flat surface 310a and a first etched surface 310b formed at one side of the first flat surface 310a, and further include the first rear surface 310c facing the first flat surface 310a.

The first flat surface 310a of the first glass substrate 310 may overlap a flat area FA of the display device 20.

A first bending etched portion 324 is formed on the rear surfaces of the first glass substrate 310 and the dummy glass substrate 320 located in the bending area BA overlapping the etching prevention member 340. The first bending etched portion 324 includes the first etched surface 310b formed on the rear surface of the first glass substrate 310 and the second etched surface 320b formed on the rear surface of the dummy glass substrate 320.

The first etched surface 310b may be formed in the remaining portion except for the first flat surface 310a among an upper surface of the first glass substrate 310 overlapping the display area DA and the bending area BA.

The first etched surface 310b may be formed in a streamlined and convex cross-sectional shape while having a non-flat structure by performing an etching process on the first glass substrate 310 having a flat plate shape and removing (or etching) a portion of the first flat surface 310a. Further, the first etched surface 310b may be provided to have a continuous surface with the first flat surface 310a.

The first etched surface 310b of the first glass substrate 310 and the second etched surface 320b of the dummy glass substrate 320 may have a reverse tapered shape and a curved surface.

Further, although not shown in the drawings, the second bending etched portion (not shown, 124 in FIG. 9) may be formed at the rear surface of the dummy glass substrate 320 located in the driving circuit area (not shown, DCA in FIG. 7) overlapping the etching prevention member 340. In this case, the second bending etched portion may be formed to have a continuous surface with the first bending etched portion.

In the driving circuit area DCA, driving circuits 360 connected to a plurality of link line units 350, and a plurality of flexible printed circuits (FPCs) 362 connected to the driving circuits 360 are disposed. The plurality of link line units 350 are respectively connected to external printed circuit boards (PCBs) 364 through the plurality of FPCs 362 which are flexible films. Although not shown in the drawing, a thin film transistor 330 including a gate electrode, an ohmic contact layer, a source electrode, and a drain electrode is formed on the first flat surface 310a of the first glass substrate 310 of the display area DA.

A planarization layer 332 is formed on a front surface of the first flat surface 310a including the thin film transistor 330, and a pixel electrode 334 electrically connected to the thin film transistor 330 is formed on the planarization layer 332.

A first alignment film 336 may be formed on the pixel electrode 334 to facilitate the alignment of liquid crystals.

Meanwhile, black matrices 420 are formed at a certain interval on the second glass substrate 410 disposed to correspond to the first glass substrate 310 of the display area DA with a certain cell gap.

The black matrices 420 may have a closed loop shape surrounding the display area DA to block light leakage. Further, the black matrices 420 may also correspond to an area corresponding to a thin film transistor (TFT, not shown), gate lines (not shown), and data lines of the first glass substrate 310 to block light leakage. In addition, the black matrices 420 are provided between color filter layers 430 to prevent or reduce color mixing between the color filter layers 430.

Red (R), green (G), and blue (B) color filter layers 430 which filter only light in a specific wavelength range may be provided between the black matrices 420. The color filter layers 430 may include an acrylic resin and a pigment. The color filter layers 430 may be divided into red (R), green (G), and blue (B) according to the type of pigment which implements a color.

Further, an overcoat layer (not shown) may be further formed on the black matrices 420 and the color filter layers 430. The overcoat layer (not shown) may be provided to protect the color filter layers 430, flatten the surfaces, and improve adhesion with a common electrode, and may be composed of an acrylic-based resin.

A common electrode 440 may be provided on the overcoat layer. The common electrode 440 may be formed of a transparent conductive material. For example, the common electrode 440 may be composed of indium tin oxide (ITO) or indium zinc oxide (IZO).

A second alignment film 442 is formed on the common electrode 440 to facilitate the alignment of liquid crystals.

Meanwhile, although not shown in the drawings, a spacer (not shown) which serves to maintain the certain cell gap may be additionally formed between the first glass substrate 310 and the second glass substrate 410.

Further, since a seal line 470 is disposed in the non-display area NDA of the first glass substrate 310 and the second glass substrate 410, the first and second glass substrates 310 and 410 are bonded.

The seal line 470 may be provided on the planarization layer 332 to be spaced apart from the first alignment film 336, and may be disposed to face the planarization layer 332 and the black matrices 420. The seal line 470 may be composed of a sealant, and for example, the sealant may be a photo-curable epoxy resin or thermo-curable epoxy resin. The seal line 470 forms a gap for liquid crystal injection, and serves to prevent the injected liquid crystals from leaking. This seal line 470 is formed by forming a thermo-curable resin in a certain pattern on the first glass substrate 310, and then disposing the second glass substrate 410 on the first glass substrate 310 and pressing and curing the first glass substrate 310 and the second glass substrate 410 to bond the two substrates 310 and 410.

A liquid crystal layer 450 may be provided in an area where the certain cell gap is formed between the first glass substrate 310 and the second glass substrate 410. The liquid crystal layer may include liquid crystals having optical anisotropic properties.

In the display device 20 according to another example embodiment of the present disclosure, a voltage is applied to the pixel electrode 334 through the drain electrode and a voltage is applied to the common electrode 440 to display an image by driving a liquid crystal cell.

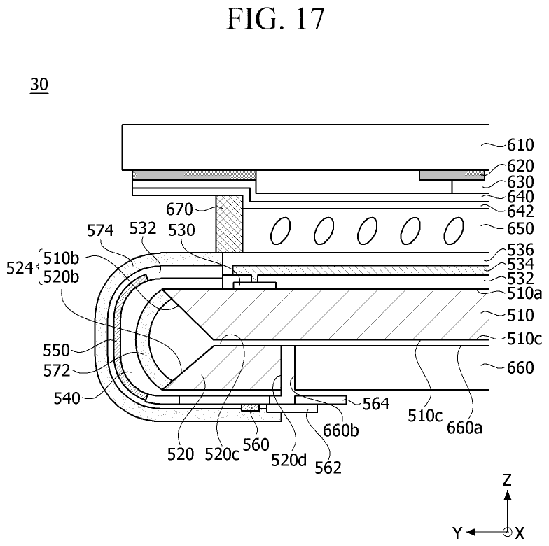

Meanwhile, a display device according to still another example embodiment of the present disclosure will be described with reference to FIG. 17 as follows.

FIG. 17 is a cross-sectional view of the display device according to still another example embodiment of the present disclosure.

A display device 30 according to still another example embodiment of the present disclosure has the same configuration as that of the display device 10 according to one example embodiment of the present disclosure in FIG. 5 except for the configuration in which a dummy glass substrate 520 is disposed on a lower surface of a first glass substrate 510, and a light source unit 660 is disposed on a side surface of the first glass substrate 510.

As shown in FIG. 17, the display device 30 according to still another example embodiment of the present disclosure includes the first glass substrate 510 including a display area DA and a non-display area NDA including a bending area BA, and a second glass substrate 610 disposed on the first glass substrate 510 in the display area DA to face the first glass substrate 510 with a certain cell gap.

The dummy glass substrate 520 is bent from the first glass substrate 510 and located at a lower side of the first glass substrate 510 with the bending area BA of the non-display area NDA therebetween.

An etching prevention member 540 is formed on the first glass substrate 510 and the dummy glass substrate 520 to overlap the bending area BA. A link line unit 550 overlapping the bending area BA is disposed on the etching prevention member 540.

A first coating layer 572 is formed under the etching prevention member 540. Further, a second coating layer 574 is formed on the planarization layer 532 formed on the etching prevention member 540.

A rear surface 520c of the bent dummy glass substrate 520 is disposed in contact with a rear surface 510c of the first glass substrate 510 located in the display area DA. Further, a side surface 660b of the light source unit 660 is disposed in contact with a side surface 520d of the dummy glass substrate 520. A 2D micro-LED (μ-LED) may be applied as the light source unit 660. The present disclosure is not limited thereto, and other light sources may also be applied.

Further, a front surface 660a of the light source unit 660 is disposed in contact with the rear surface 510c of the first glass substrate 510.

A contact portion of the first rear surface 510c of the first glass substrate 510 and the front surface 660a of the light source unit 660, and the side surface 520d of the dummy glass substrate 520 and the side surface 660b of the light source unit 660 may further include an adhesive member (not shown) for fixing the light source unit 660 and the dummy glass substrate 520 to the first glass substrate 510.

The adhesive member (not shown) may be an optically clear adhesive (OCA), an optically clear resin (OCR), a pressure sensitive adhesive (PSA), or a double-sided adhesive tape, but is not limited thereto.

The first glass substrate 510 may include a first flat surface 510a and a first etched surface 510b formed at one side of the first flat surface 510a, and further include the first rear surface 510c facing the first flat surface 510a.

The first flat surface 510a of the first glass substrate 510 may overlap a flat area FA of the display device 30.

A first bending etched portion 524 is formed on the rear surfaces of the first glass substrate 510 and the dummy glass substrate 520 located in the bending area BA overlapping the etching prevention member 540. The first bending etched portion 524 includes the first etched surface 510b formed on the rear surface of the first glass substrate 510 and a second etched surface 520b formed on the rear surface of the dummy glass substrate 520.

The first etched surface 510b may be formed in the remaining portion except for the first flat surface 510a among an upper surface of the first glass substrate 510 overlapping the display area DA and the bending area BA.

The first etched surface 510b may be formed in a streamlined and convex cross-sectional shape while having a non-flat structure by performing an etching process on the first glass substrate 510 having a flat plate shape and removing (or etching) a portion of the first flat surface 510a. Further, the first etched surface 510b may be provided to have a continuous surface with the first flat surface 510a.

The first etched surface 510b of the first glass substrate 510 and the second etched surface 520b of the dummy glass substrate 520 may have a reverse tapered shape and a curved surface.

Further, although not shown in the drawings, the second bending etched portion (not shown, 124 in FIG. 9) may be formed at the rear surface of the dummy glass substrate 520 located in the driving circuit area (not shown, DCA in FIG. 7) overlapping the etching prevention member 540. The second bending etched portion may be formed to have a continuous surface with the first bending etched portion 524.

Although not shown in the drawing, a thin film transistor 530 including a gate electrode, an ohmic contact layer, a source electrode, and a drain electrode is formed on the first flat surface 510a of the first glass substrate 510 of the display area DA.

A planarization layer 532 is formed on a front surface of the first flat surface 510a including the thin film transistor 530, and a pixel electrode 534 electrically connected to the thin film transistor 530 is formed on the planarization layer 532.

A first alignment film 536 may be formed on the pixel electrode 534 to facilitate the alignment of liquid crystals.

Meanwhile, black matrices 620 are formed at a certain interval on the second glass substrate 610 disposed to correspond to the first glass substrate 510 of the display area DA with a certain cell gap.

The black matrices 620 may have a closed loop shape surrounding the display area DA to block light leakage. Further, the black matrices 620 may also correspond to an area corresponding to a thin film transistor (TFT, not shown), gate lines (not shown), and data lines of the first glass substrate 510 to block light leakage. In addition, the black matrices 620 are provided between color filter layers 630 to prevent or reduce color mixing between the color filter layers 630.

Red (R), green (G), and blue (B) color filter layers 630 which filter only light in a specific wavelength range may be provided between the black matrices 620. The color filter layers 630 may include an acrylic resin and a pigment. The color filter layers 630 may be divided into red (R), green (G), and blue (B) according to the type of pigment which implements a color.

Further, an overcoat layer (not shown) may be further formed on the black matrices 620 and the color filter layers 630. The overcoat layer (not shown) may be provided to protect the color filter layers 630, flatten the surfaces, and improve adhesion with a common electrode, and may be composed of an acrylic-based resin.

A common electrode 640 may be provided on the overcoat layer. The common electrode 640 may be formed of a transparent conductive material. For example, the common electrode 640 may be composed of indium tin oxide (ITO) or indium zinc oxide (IZO).

A second alignment film 642 is formed on the common electrode 640 to facilitate the alignment of liquid crystals.

Meanwhile, although not shown in the drawings, a spacer (not shown) which serves to maintain the certain cell gap may be additionally formed between the first glass substrate 510 and the second glass substrate 610.

Further, since a seal line 670 is disposed in the non-display area NDA of the first glass substrate 510 and the second glass substrate 610, the first and second glass substrates 510 and 610 are bonded.

The seal line 670 may be provided on the planarization layer 532 to be spaced apart from the first alignment film 536, and may be disposed to face the planarization layer 532 and the black matrices 620. The seal line 670 may be composed of a sealant, and for example, the sealant may be a photo-curable epoxy resin or thermo-curable epoxy resin. The seal line 670 forms a gap for liquid crystal injection, and serves to prevent the injected liquid crystals from leaking. This seal line 670 is formed by forming a thermo-curable resin in a certain pattern on the first glass substrate 510, and then disposing the second glass substrate 610 on the first glass substrate 510 and pressing and curing the first glass substrate 510 and the second glass substrate 610 to bond the two substrates 510 and 610.

A liquid crystal layer 650 may be provided in an area where the certain cell gap is formed between the first glass substrate 510 and the second glass substrate 610. The liquid crystal layer may include liquid crystals having optical anisotropic properties.

In the display device 30 according to still another example embodiment of the present disclosure, a voltage is applied to the pixel electrode 534 through the drain electrode and a voltage is applied to the common electrode 640 to display an image by driving a liquid crystal cell.

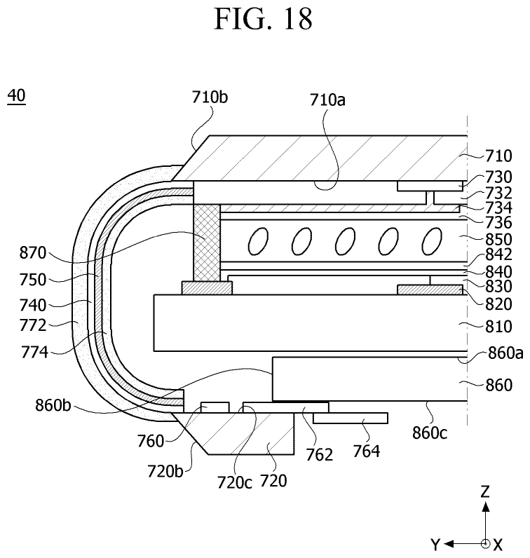

Meanwhile, a display device according to yet another example embodiment of the present disclosure will be described with reference to FIG. 18 as follows.

FIG. 18 is a cross-sectional view of the display device according to yet another example embodiment of the present disclosure.

A display device 40 according to yet another example embodiment of the present disclosure gas the same configuration as that of the display device 10 according to an example embodiment of the present disclosure in FIG. 5 except for the configuration in which a first glass substrate 710, which is a thin film transistor array substrate, is disposed on a second glass substrate 810, which is a color filter array substrate, and a dummy glass substrate 720 etched and bent from the first glass substrate 710 is disposed in contact with a lower surface of a light source unit 860 disposed in contact with a rear surface of the first glass substrate 710.

As shown in FIG. 18, The display device 40 according to yet another example embodiment of the present disclosure includes the first glass substrate 710 including a display area DA and a non-display area NDA including a bending area BA, and the second glass substrate 810 disposed under the first glass substrate 710 in the display area DA to face the first glass substrate 710 with a certain cell gap.

The dummy glass substrate 720 is bent from the first glass substrate 710 and located at a lower side of the second glass substrate 810 with the bending area BA of the non-display area NDA therebetween.

An etching prevention member 740 is formed on the first glass substrate 710 and the dummy glass substrate 720 to overlap the bending area BA. A link line unit 750 overlapping the bending area BA is disposed on the etching prevention member 740.

A first coating layer 772 is formed under the etching prevention member 740. Further, a second coating layer 774 is formed on the planarization layer 732 formed on the etching prevention member 740. A front surface 860a of the light source unit 860 is disposed in contact with a rear surface 810c of the second glass substrate 810 located in the display area DA. Further, a rear surface 720c of the dummy glass substrate 720 is disposed in contact with a rear surface 860c of the light source unit 860. A 2D micro-LED (μ-LED) may be applied as the light source unit 860. The light source unit 860 is not limited thereto, and other light sources may also be applied.

A contact portion of the rear surface 810c of the second glass substrate 810 and the front surface 860a of the light source unit 860, and the rear surface 720c of the dummy glass substrate 720 and the rear surface 860c of the light source unit 860 may further include an adhesive member (not shown) for fixing the light source unit 860 and the dummy glass substrate 720 to the second glass substrate 810.

The adhesive member (not shown) may be an optically clear adhesive (OCA), an optically clear resin (OCR), a pressure sensitive adhesive (PSA), or a double-sided adhesive tape, but is not limited thereto.

The first glass substrate 710 may include a first flat surface 710a and a first etched surface 710b formed at one side of the first flat surface 710a, and further include the first rear surface 710c facing the first flat surface 710a.

The first flat surface 710a of the first glass substrate 710 may overlap a flat area FA of the display device 40.

The first etched surface 710b is formed on the rear surface of the first glass substrate 710 located in the bending area BA overlapping the etching prevention member 740, and the second etched surface 720b is formed on the rear surface of the dummy glass substrate 720.

The first etched surface 710b may be formed in the remaining portion except for the first flat surface 710a among an upper surface of the first glass substrate 710 overlapping the display area DA and the bending area BA.

The first etched surface 710b may be formed in a streamlined and convex cross-sectional shape while having a non-flat structure by performing an etching process on the first glass substrate 710 having a flat plate shape and removing (or etching) a portion of the first flat surface 710a. Further, the first etched surface 710b may be provided to have a continuous surface with the first flat surface 710a.

The first etched surface 710b of the first glass substrate 710 and the second etched surface 720b of the dummy glass substrate 720 may have a reverse tapered shape and a curved surface.

Further, although not shown in the drawings, the bending etched portion (not shown, 124 in FIG. 9) may be formed at the rear surface of the dummy glass substrate 720 located in the driving circuit area (not shown, DCA in FIG. 7) overlapping the etching prevention member 740. The bending etched portion may be formed to have a continuous surface with the second etched surface 720b of the dummy glass substrate 720.

Although not shown in the drawing, a thin film transistor 730 including a gate electrode, an ohmic contact layer, a source electrode, and a drain electrode is formed on the first flat surface 710a of the first glass substrate 710 of the display area DA.

A planarization layer 732 is formed on a front surface of the first flat surface 710a including the thin film transistor 730, and a pixel electrode 734 electrically connected to the thin film transistor 730 is formed on the planarization layer 732.

A first alignment film 736 may be formed on the pixel electrode 734 to facilitate the alignment of liquid crystals.

Meanwhile, black matrices 820 are formed at a certain interval on the second glass substrate 810 disposed to correspond to the first glass substrate 710 of the display area DA with a certain cell gap.

The black matrices 820 may have a closed loop shape surrounding the display area DA to block light leakage. Further, the black matrices 820 may also correspond to an area corresponding to a thin film transistor (TFT, not shown), gate lines (not shown), and data lines of the first glass substrate 710 to block light leakage. In addition, the black matrices 820 are provided between color filter layers 830 to prevent or reduce color mixing between the color filter layers 830.

Red (R), green (G), and blue (B) color filter layers 830 which filter only light in a specific wavelength range may be provided between the black matrices 820. The color filter layers 830 may include an acrylic resin and a pigment. The color filter layers 830 may be divided into red (R), green (G), and blue (B) according to the type of pigment which implements a color.

Further, an overcoat layer (not shown) may be further formed on the black matrices 820 and the color filter layers 830. The overcoat layer (not shown) may be provided to protect the color filter layers 830, flatten the surfaces, and improve adhesion with a common electrode, and may be composed of an acrylic-based resin.

A common electrode 840 may be provided on the overcoat layer. The common electrode 840 may be formed of a transparent conductive material. For example, the common electrode 840 may be composed of indium tin oxide (ITO) or indium zinc oxide (IZO).

A second alignment film 842 is formed on the common electrode 840 to facilitate the alignment of liquid crystals.

Meanwhile, although not shown in the drawings, a spacer (not shown) which serves to maintain the certain cell gap may be additionally formed between the first glass substrate 710 and the second glass substrate 810.

Further, since a seal line 870 is disposed in the non-display area NDA of the first glass substrate 710 and the second glass substrate 810, the first and second glass substrates 710 and 810 are bonded.

The seal line 870 may be provided on the planarization layer 732 to be spaced apart from the first alignment film 736, and may be disposed to face the planarization layer 732 and the black matrices 820. The seal line 870 may be composed of a sealant, and for example, the sealant may be a photo-curable epoxy resin or thermo-curable epoxy resin. The seal line 870 forms a gap for liquid crystal injection, and serves to prevent the injected liquid crystals from leaking. This seal line 870 is formed by forming a thermo-curable resin in a certain pattern on the first glass substrate 710, and then disposing the second glass substrate 810 on the first glass substrate 710 and pressing and curing the first glass substrate 710 and the second glass substrate 810 to bond the two substrates 710 and 810.

A liquid crystal layer 850 may be provided in an area where the certain cell gap is formed between the first glass substrate 710 and the second glass substrate 810. The liquid crystal layer may include liquid crystals having optical anisotropic properties.

In the display device 40 according to yet another example embodiment of the present disclosure, a voltage is applied to the pixel electrode 734 through the drain electrode and a voltage is applied to the common electrode 840 to display an image by driving a liquid crystal cell.

The display device according to example embodiments of the present disclosure may be applied to a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an electronic book, a portable multimedia player (PMP), a personal digital assistant (PDA), an MP3 player, a mobile medical apparatus, a desktop personal computer (PC), a laptop PC, a netbook computer, a workstation, a navigation device, a vehicle display device, a theater display device, a television, a wallpaper apparatus, a signage apparatus, a gaming apparatus, a laptop PC, a monitor, a camera, a camcorder, a home appliance, and the like.

According to the present disclosure, as a two-dimensional (2D) micro light-emitting diode (LED) is applied as a backlight unit and a bending area overlapping a link line unit through patterning etching of a glass substrate is bent, a bezel in a lower end portion can be reduced to implement a four-sided even bezel.

According to the present disclosure, as the glass substrate located in the bending area is etched and an etching prevention member under the link line unit is applied, bezel bending can be implemented, and thus a bezel width can be reduced as much as a link line area and a driving circuit area through bezel bending.

According to the present disclosure, since a dummy glass substrate is bent by dividing a driving circuit area and a flexible printed circuit board (FPC) area of the dummy glass substrate into a plurality of blocks to additionally etch the driving circuit areas between the blocks with the bending area of the non-display area of the glass substrate, a dummy glass size is reduced and thus rigidity can increase.

Display devices according to various example embodiments of the present disclosure may be described as follows.

A display device according to an example embodiment of the present disclosure may comprise a first substrate including a display area and a non-display area including a bending area, a second substrate disposed on the display area of the first substrate to face the first substrate with a certain gap, a dummy substrate disposed to face a lower portion of the first substrate with the bending area of the non-display area therebetween, an etching prevention member provided on the first substrate and the dummy substrate to overlap the non-display area, and a link line unit formed on the etching prevention member.

A display device according to one or more embodiments of the present disclosure may further comprise a bending portion formed on rear surfaces of the first substrate and the dummy substrate under the etching prevention member.

In a display device according to one or more embodiments of the present disclosure, the bending portion may include a first etched surface provided on the rear surface of the first substrate and a second etched surface provided on the rear surface of the dummy substrate to overlap the bending area.

In a display device according to one or more embodiments of the present disclosure, the bending portion further may include a third etched surface and a fourth etched surface formed to have a continuous surface perpendicular to the second etched surface with the link line unit therebetween on the rear surface of the dummy substrate.

In a display device according to one or more embodiments of the present disclosure, the etching prevention member may be composed of one of metal and an organic material.

In a display device according to one or more embodiments of the present disclosure, the etching prevention member may include at least one of a silicone-based organic material, urethane, polyimide, and photo acrylic as the organic material, or includes at least one of chromium (Cr), aluminum (Al), platinum (Pt), and nickel (Ni) as the metal.

In a display device according to one or more embodiments of the present disclosure, an inorganic film may be further formed or a metal film and an inorganic film may be further formed between the etching prevention member and the first substrate and the dummy substrate.

In a display device according to one or more embodiments of the present disclosure, the inorganic film may include SiO₂, SiNₓ, or a-Si; and the metal film may include molybdenum (Mo), MoTi, or ITO.

A display device according to one or more embodiments of the present disclosure, may further comprise a first coating layer disposed between the first substrate and the dummy substrate under the etching prevention member, and a planarization layer and a second coating layer disposed on the link line unit.

A display device according to one or more embodiments of the present disclosure may further comprise a liquid crystal layer disposed between the first substrate and the second substrate.

A display device according to one or more embodiments of the present disclosure may further comprise a light source unit disposed under the first substrate.

In a display device according to one or more embodiments of the present disclosure, the light source unit may be disposed between the first substrate and the dummy substrate or disposed to be in contact with a rear surface of the first substrate and a side surface of the dummy substrate.

In a display device according to one or more embodiments of the present disclosure, the light source unit may include a two-dimensional (2D) micro light-emitting diode (LED) (μ-LED).

A display device according to another example embodiment of the present disclosure may comprise a first glass substrate including a display area and a non-display area including a bending area, a second glass substrate disposed on the display area of the first glass substrate to face the first glass substrate with a certain gap, a liquid crystal layer disposed between the first and second glass substrates, a light source unit disposed on a rear surface of the first glass substrate, a dummy glass substrate disposed to face a lower portion of the first glass substrate with the bending area of the non-display area therebetween, an etching prevention member provided on the first glass substrate and the dummy glass substrate to overlap the non-display area, a link line unit formed on the etching prevention member, and a bending portion formed on rear surfaces of the first glass substrate and the dummy glass substrate under the etching prevention member.

In a display device according to one or more embodiments of the present disclosure, the bending portion may include a first etched surface provided on the rear surface of the first glass substrate and a second etched surface provided on the rear surface of the dummy glass substrate to overlap the bending area, and further includes a third etched surface and a fourth etched surface formed to have a continuous surface perpendicular to the second etched surface with the link line unit therebetween on the rear surface of the dummy glass substrate.

A display device according to one or more embodiments of the present disclosure may further comprise a first coating layer disposed between the first glass substrate and the dummy glass substrate under the etching prevention member, and a planarization layer and a second coating layer disposed on the link line unit.

A display device according to another example embodiment of the present disclosure may comprise a first glass substrate including a display area and a non-display area including a bending area, a second glass substrate disposed on the display area of the first glass substrate to face the first glass substrate with a certain gap, a liquid crystal layer disposed between the first and second glass substrates, a dummy glass substrate disposed at a lower side of the first glass substrate with the bending area of the non-display area therebetween, a light source unit disposed on a rear surface of the first glass substrate and a side surface of the dummy glass substrate, an etching prevention member provided on the first glass substrate and the dummy glass substrate to overlap the non-display area, a link line unit formed on the etching prevention member, and a bending portion formed on rear surfaces of the first glass substrate and the dummy glass substrate under the etching prevention member.

In a display device according to one or more embodiments of the present disclosure, the bending portion may include a first etched surface provided on the rear surface of the first glass substrate and a second etched surface provided on the rear surface of the dummy glass substrate to overlap the bending area, and further includes a third etched surface and a fourth etched surface formed to have a continuous surface perpendicular to the second etched surface with the link line unit therebetween on the rear surface of the dummy glass substrate.

A display device according to one or more embodiments of the present disclosure may further comprise a first coating layer disposed between the first glass substrate and the dummy glass substrate under the etching prevention member, and a planarization layer and a second coating layer disposed on the link line unit.

In a display device according to one or more embodiments of the present disclosure, the light source unit includes a 2D micro-LED (μ-LED).

A display device according to another example embodiment of the present disclosure may include a thin film transistor array substrate including a display area and a non-display area including a bending area, a color filter array substrate disposed on the display area of the thin film transistor array substrate to face the thin film transistor array substrate with a certain gap, a liquid crystal layer disposed between the thin film transistor array substrate and the color filter array substrate, a dummy glass substrate bent from the thin film transistor array substrate across the bending area of non-display area and disposed below the color filter array substrate, a light source unit disposed on a rear surface of the color filter array substrate and the dummy glass substrate, an etching prevention member provided on the thin film transistor array substrate and the dummy glass substrate to overlap the non-display area, a link line unit disposed on the etching prevention member, and a bending portion formed on rear surfaces of the thin film transistor array substrate and the dummy glass substrate under the etching prevention member.

In a display device according to one or more embodiments of the present disclosure, the bending portion may include a first etched surface provided on the rear surface of the thin film transistor substrate and a second etched surface provided on the rear surface of the dummy glass substrate to overlap the bending area, and further includes a third etched surface and a fourth etched surface formed to have a continuous surface perpendicular to the second etched surface with the link line unit therebetween on the rear surface of the dummy glass substrate.

Since the contents of the disclosure described in the problems to be solved, the means to solve the problems, and the effects described above do not specify the essential features of the claims, the scope of the claims is not limited by items described in the contents of the disclosure.

Although example embodiments have been described in more detail with reference to the accompanying drawings, the present disclosure is not necessarily limited to these example embodiments and may be variously modified without departing from the technical spirit of the present disclosure. Accordingly, the example embodiments disclosed in the present disclosure are not intended to limit the technical spirit of the present disclosure, but to describe the technical spirit of the present disclosure, and the scope of the technical spirit of the present disclosure is not limited by these example embodiments. Accordingly, the above-described example embodiments should be understood as in all respects as illustrative and not restrictive.

What is claimed is:

1. A display device, comprising:
a first substrate including a display area and a non-display area including a bending area;
a second substrate disposed on the display area of the first substrate to face the first substrate with a certain gap;
a dummy substrate disposed to face a lower portion of the first substrate with the bending area of the non-display area therebetween;
an etching prevention member provided on the first substrate and the dummy substrate to overlap the non-display area; and
a link line unit formed on the etching prevention member.

2. The display device of claim 1, further comprising a bending portion formed on rear surfaces of the first substrate and the dummy substrate under the etching prevention member.

3. The display device of claim 2, wherein the bending portion includes a first etched surface provided on the rear surface of the first substrate and a second etched surface provided on the rear surface of the dummy substrate to overlap the bending area.

4. The display device of claim 3, wherein the bending portion further includes a third etched surface and a fourth etched surface formed to have a continuous surface perpendicular to the second etched surface with the link line unit interposed between the third surface and the fourth etched surface on the rear surface of the dummy substrate.

5. The display device of claim 1, wherein the etching prevention member is composed of one of metal and an organic material.

6. The display device of claim 5, wherein the etching prevention member includes at least one of a silicone-based organic material, urethane, polyimide, and photo acrylic as the organic material, or includes at least one of chromium (Cr), aluminum (Al), platinum (Pt), and nickel (Ni) as the metal.

7. The display device of claim 1, wherein an inorganic film is further formed or a metal film and an inorganic film are further formed between the etching prevention member and the first substrate as well as between the etching prevention member and the dummy substrate.

8. The display device of claim 7, wherein:
the inorganic film includes SiO₂, SiNₓ, or a-Si; and
the metal film includes molybdenum (Mo), MoTi, or ITO.

9. The display device of claim 1, further comprising:
a first coating layer disposed between the first substrate and the dummy substrate under the etching prevention member; and
a planarization layer and a second coating layer disposed on the link line unit.

10. The display device of claim 1, further comprising a liquid crystal layer disposed between the first substrate and the second substrate.

11. The display device of claim 1, further comprising a light source unit disposed under the first substrate.

12. The display device of claim 11, wherein the light source unit is disposed between the first substrate and the dummy substrate or disposed to be in contact with a rear surface of the first substrate and a side surface of the dummy substrate.

13. The display device of claim 11, wherein the light source unit includes a two-dimensional (2D) micro light-emitting diode (LED) (μ-LED).

14. A display device, comprising:
a first glass substrate including a display area and a non-display area including a bending area;
a second glass substrate disposed on the display area of the first glass substrate to face the first glass substrate with a certain gap;
a liquid crystal layer disposed between the first glass substrate and the second glass substrate;
a light source unit disposed on a rear surface of the first glass substrate;
a dummy glass substrate disposed to face a lower portion of the first glass substrate with the bending area of the non-display area therebetween;
an etching prevention member provided on the first glass substrate and the dummy glass substrate to overlap the non-display area;
a link line unit formed on the etching prevention member; and
a bending portion formed on rear surfaces of the first glass substrate and the dummy glass substrate under the etching prevention member.

15. The display device of claim 14, wherein the bending portion includes:
a first etched surface provided on the rear surface of the first glass substrate and a second etched surface provided on the rear surface of the dummy glass substrate to overlap the bending area; and
a third etched surface and a fourth etched surface formed to have a continuous surface perpendicular to the second etched surface with the link line unit interposed between the third etched surface and the fourth etched surface on the rear surface of the dummy glass substrate.

16. The display device of claim 14, further comprising:
a first coating layer disposed between the first glass substrate and the dummy glass substrate under the etching prevention member; and
a planarization layer and a second coating layer disposed on the link line unit.

17. A display device, comprising:
a first glass substrate including a display area and a non-display area including a bending area;
a second glass substrate disposed on the display area of the first glass substrate to face the first glass substrate with a certain gap;
a liquid crystal layer disposed between the first glass substrate and the second glass substrate;
a dummy glass substrate disposed at a lower side of the first glass substrate with the bending area of the non-display area therebetween;
a light source unit disposed on a rear surface of the first glass substrate and a side surface of the dummy glass substrate;
an etching prevention member provided on the first glass substrate and the dummy glass substrate to overlap the non-display area;
a link line unit formed on the etching prevention member; and
a bending portion formed on rear surfaces of the first glass substrate and the dummy glass substrate under the etching prevention member.

18. The display device of claim 17, wherein the bending portion includes:
a first etched surface provided on the rear surface of the first glass substrate and a second etched surface provided on the rear surface of the dummy glass substrate to overlap the bending area; and
a third etched surface and a fourth etched surface formed to have a continuous surface perpendicular to the second etched surface with the link line unit interposed between the third etched surface and the fourth etched surface on the rear surface of the dummy glass substrate.

19. The display device of claim 17, further comprising:
a first coating layer disposed between the first glass substrate and the dummy glass substrate under the etching prevention member; and
a planarization layer and a second coating layer disposed on the link line unit.

20. The display device of claim 17, wherein the light source unit includes a 2D micro-LED (μ-LED).
